(19) United States
(12) Patent Application Publication
(10) Pub. No.: US 2021/0308870 A1
(43) Pub. Date: Oct. 7, 2021

(54) AUTOMATIC BUMPER PROCESSING

(71) Applicant: JR Automation Technologies, LLC, Holland, MI (US)

(72) Inventor: Josh Benson, Holland, MI (US)

(21) Appl. No.: 17/222,688

(22) Filed: Apr. 5, 2021

Related U.S. Application Data
(60) Provisional application No. 63/006,037, filed on Apr. 6, 2020.

(51) Int. Cl. B25J 9/16; B25J 19/02; B23K 37/047; B23K 101/00

(52) U.S. Cl. CPC B25J 9/1697; B23K 2101/006; B23K 37/047; B25J 19/023

(57) ABSTRACT

An automatic bumper processing system and method comprises a punch station, a welding station, a bumper positioning robot arm, a robot arm platform, a rotating mechanism, and a control station. The punch station includes a camera and a punch mechanism, the camera capturing an image of a bumper and the punch mechanism punching a hole through the bumper. The welding station includes a welding robot arm including a welder to weld an automotive component onto the bumper. The bumper positioning robot arm positions the bumper proximate to the punch station and positions the bumper proximate to the welding station. The bumper positioning robot arm is coupled to the robot arm platform. The rotating mechanism rotates the robot arm platform and positions the bumper positioning robot arm proximate to the punch station and the welding station.

### CROSS-REFERENCE TO RELATED APPLICATION

This application claims priority from U.S. Provisional Patent Application Ser. No. 63/006,037 filed on Apr. 6, 2020, entitled “BUMPER AUTOMATION”, the disclosure of which is hereby incorporated by reference in its entirety.

### BACKGROUND OF THE DISCLOSURE

### 1. Field of the Disclosure

The disclosure relates in general to automation, and more particularly, to bumper processing automation.

### 2. Background Art

The automotive industry increasingly relies on robots to assemble cars. Such robots increase safety, reduce production time, provide high quality and precision assembly, increase precision of parts, reduce damage to parts, analyze parts for defects, detect part variations as a basis of compensating for the variations, reduce downtime, increase flexibility, etc. The robots perform such functions as handling engine castings in a foundry, laser-cutting, tending forming presses and molding machines, packaging, painting, coating, sealing, welding (e.g., spot welding), trimming and cutting, movement of heated parts, palletizing functions, etc. The robots typically include a controller, an arm, a drive, an end-effector, and one or more sensors.

### SUMMARY OF THE DISCLOSURE

The disclosure is directed to an automatic bumper processing system comprising a punch station, a welding station, a bumper positioning robot arm, a robot arm platform, a rotating mechanism, and a control station. The punch station includes a camera and a punch mechanism, the camera capturing an image of a bumper and the punch mechanism punching a hole through the bumper. The welding station includes a welding robot arm including a welder to weld an automotive component onto the bumper. The bumper positioning robot arm positions the bumper proximate to the punch station and positions the bumper proximate to the welding station. The bumper positioning robot arm is coupled to the robot arm platform. The rotating mechanism rotates the robot arm platform to position the bumper positioning robot arm proximate to the punch station and the welding station. The control station analyzes the image captured by the camera, instructs the bumper positioning robot arm to orient and position the bumper relative to the punch station, instructs the punch station to active the punch mechanism to punch the hole through the bumper at a pre-programmed location based on the image captured by the camera, instructs the bumper positioning robot arm to orient and position the bumper relative to the welding station, and instructs the welder to weld the automotive component onto the bumper.

In some configurations of the automatic bumper processing system, the bumper is a first bumper, the bumper positioning robot arm is a first bumper positioning robot arm, the hole is a first hole, and the image is a first image. The automatic bumper processing system further comprises a second bumper positioning robot arm, coupled to an opposite end of the robot arm platform from the first bumper positioning robot arm, that positions a second bumper proximate to the punch station and positions the second bumper proximate to the welding station. The control station further analyzes a second image of the second bumper captured by the camera, instructs the second bumper positioning robot arm to orient and position the second bumper relative to the punch station, instructs the punch station to active the punch mechanism to punch a second hole through the second bumper at a pre-programmed location based on the second image captured by the camera, instructs the second bumper positioning robot arm to orient and position the second bumper relative to the welding station.

In some configurations of the automatic bumper processing system, the punch mechanism is a first punch mechanism and the hole is a first hole. The punch station further comprises a punch tend robot to load a second punch mechanism into the punch station to punch a second hole into the bumper, the second hole having a different configuration than the first hole.

In some configurations of the automatic bumper processing system, the automatic bumper processing system further comprises a support block storage area, disposed proximate to the welding robot arm, to store a plurality of support blocks that support the bumper while being welded.

In some configurations of the automatic bumper processing system, the automatic bumper processing system further comprises a support block robot arm and a support block arm, both of which are disposed proximate to the welding robot arm, the support block robot arm to pick up a support block from the plurality of support blocks and place the support block onto the support arm.

In some configurations of the automatic bumper processing system, the welding robot arm is a first welding robot arm and the welder is a first welder. The welding station further includes a second welding robot arm and a second welder to weld the automotive component onto the bumper.

In some configurations of the automatic bumper processing system, the welder is one of an ultrasonic welder, hot plate welder, infrared welder, hot air welder, chemical welder, and an adhesive welder.

In some configurations of the automatic bumper processing system, the automotive component is one of a parking sensor bracket and a reflector.

In some configurations of the automatic bumper processing system, the bumper positioning robot arm is a Fanuc R-2000iC/165F robot arm and the control station is a Fanuc R-30iB controller.

In some configurations of the automatic bumper processing system, the camera is a 3 Dimensional Light Detection and Ranging (3DL) camera.

The disclosure is also directed to a method of automatically processing a bumper via an automatic bumper processing system. The method comprises capturing, by a camera disposed within a punch station, an image of a bumper, punching, by a punch mechanism disposed within the punch station, a hole through the bumper, and welding, by a welding station including a welding robot arm, an automotive component onto the bumper. The method further comprises positioning, by a robot arm, the bumper proximate to the punch station and the welding station, rotating, by a rotating mechanism, a robot arm platform coupled to the robot arm to position the robot arm proximate to the punch station and the welding station, and analyzing, by a control station, the image captured by the camera. The method even further comprises instructing, by the control station, the robot arm to orient and position the bumper relative to the punch station, instructing, by the control station, the punch station to active the punch mechanism to punch the hole through the bumper at a pre-programmed location based on the image captured by the camera, instructing, by the control station, the robot arm to orient and position the bumper relative to the welding station, and instructing, by the control station, the welder to weld the automotive component onto the bumper.

In some configurations of the method, the bumper is a first bumper, the bumper positioning robot arm is a first bumper positioning robot arm, the hole is a first hole, and the image is a first image. The method further comprises positioning, by a second bumper positioning robot arm coupled to an opposite end of the robot arm platform from the first bumper positioning robot arm, a second bumper proximate to the punch station, positioning, by the second bumper positioning robot, the second bumper proximate to the welding station, and analyzing, by the control station, a second image of the second bumper captured by the camera. The method even further comprises instructing, by the control station, the second robot positioning robot arm to orient and position the second bumper relative to the punch station, instruct, by the control station, the punch station to active the punch mechanism to punch a second hole through the second bumper at a pre-programmed location based on the second image captured by the camera, and instructing, by the control station, the second bumper positioning robot arm to orient and position the second bumper relative to the welding station.

In some configurations of the method, the punch mechanism is a first punch mechanism and the hole is a first hole. The method further comprises loading, by a punch tend robot, a second punch mechanism into the punch station to punch a second hole into the bumper, the second hole having a different configuration than the first hole.

In some configurations of the method, the method further comprises storing, by a support block storage area disposed proximate to the welding robot arm, a plurality of support blocks that support the bumper while being welded.

In some configurations of the method, the method further comprises picking up, by a support block robot arm disposed proximate to the welding robot arm, a support block from the plurality of support blocks, and placing, by the support block robot arm, the support block onto a support arm disposed proximate to the welding robot arm.

In some configurations of the method, the welding robot arm is a first welding robot arm and the welder is a first welder. The method further comprises welding, by a second welding robot arm and a second welder both disposed within the welding station, the automotive component onto the bumper.

In some configurations of the method, the welder is one of an ultrasonic welder, hot plate welder, infrared welder, hot air welder, chemical welder, and an adhesive welder.

In some configurations of the method, the automotive component is one of a parking sensor bracket and a reflector.

In some configurations of the method, the bumper positioning robot arm is a Fanuc R-2000iC/165F robot arm and the control station is a Fanuc R-30iB controller.

In some configurations of the method, the camera is a 3 Dimensional Light Detection and Ranging (3DL) camera.

### BRIEF DESCRIPTION OF THE DRAWINGS

The disclosure will now be described with reference to the drawings wherein:

FIG. 1 illustrates an isometric view of an example bumper automation system, of the present disclosure;

FIG. 2 illustrates the bumper automation system of FIG. 1 in which a first bumper is secured, of the present disclosure;

FIG. 3 illustrates the bumper automation system of FIG. 2 in which the first bumper is analyzed, of the present disclosure;

FIG. 4 illustrates the bumper automation system of FIG. 3 in which holes are punched into the first bumper, of the present disclosure;

FIG. 5 illustrates the bumper automation system of FIG. 4 in which a robot arm platform is rotated, of the present disclosure;

FIG. 6 illustrates the bumper automation system of FIG. 5 in which the robot arm platform rotation is shown as being completed, of the present disclosure;

FIG. 7 illustrates the bumper automation system of FIG. 6 in which the first bumper is welded and a second bumper is secured, of the present disclosure;

FIG. 8 illustrates the bumper automation system of FIG. 7 in which the first bumper is welded and the second bumper is analyzed, of the present disclosure;

FIG. 9 illustrates the bumper automation system of FIG. 8 in which the first bumper is welded and the second bumper is analyzed, of the present disclosure;

FIG. 10 illustrates the bumper automation system of FIG. 9 in which the first bumper is placed on a conveyor and the second bumper is punched, of the present disclosure;

FIG. 11 illustrates the bumper automation system of FIG. 10 in which the robot arm platform is rotated, of the present disclosure;

FIG. 12 illustrates an example general-purpose computing device of the present disclosure;

FIG. 13 illustrates an example of an automotive bracket coupled to a bumper, of the present disclosure;

FIG. 14 illustrates another example of an automotive bracket coupled to a bumper, of the present disclosure; and

FIG. 15 illustrates yet another example of an automotive bracket coupled to a bumper, of the present disclosure.

### DETAILED DESCRIPTION OF THE DISCLOSURE

While this disclosure is susceptible of embodiment(s) in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

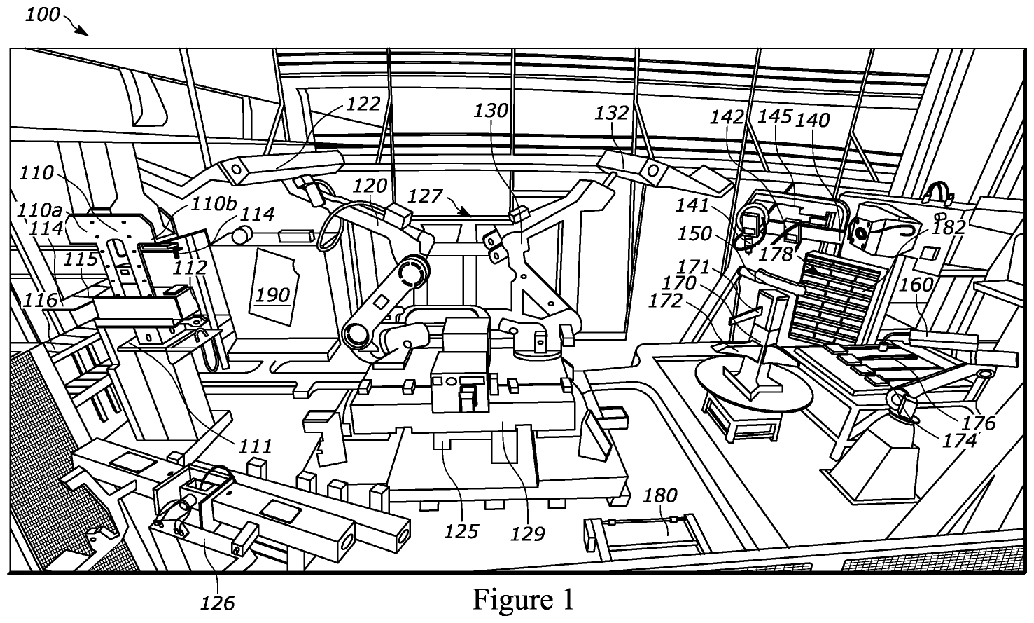

Referring now to the drawings and in particular to FIG. 1, a system or bumper punch and weld cell is disclosed, such as automatic bumper processing system 100 for automatically processing a bumper for an automobile (e.g., car, truck, or any other automobile). The automatic bumper processing system 100 performs such automatic processing functions as punching holes in a bumper and welding automotive components onto the bumper, particularly precisely lined up with the punched holes. Functionality of the automatic bumper processing system 100 will first be described and, thereafter, a sequence of operations performed by the automatic bumper processing system 100 will be described. With the flexibility provided by the various components described herein, the automatic bumper processing system 100 is able to run in a “Lot Size of One” mode in which the automatic bumper processing system 100 is able to process a small quantity of bumpers, such as for bumpers for delivery on a specific date or manufactured in a single production run. Alternatively, the automatic bumper processing system 100 is able to process large quantities of bumpers for an entire model run for a particular automobile(s).

The automatic bumper processing system 100 includes a punch station 110, a first bumper positioning robot arm 120, a rotating mechanism 125, a second bumper positioning robot arm 130, a first welding robot arm 140, a second welding robot arm 145, automotive component robot arm 160, a support block robot arm 150, a welding station 170, and a control station 190 to instruct and control operation of these components within the automatic bumper processing system 100, as described herein. Bumper positioning robot arms 120, 130 can be typical robot components, such as Fanuc R-2000iC/165F and Controller, and iRVision—3DL—3D Guidance. Each of the robot arms 150, 160 include grippers to grab welding support blocks 178 and automotive components 174 (e.g., parking sensor brackets, reflectors, etc.) as necessary during their respective operations. The “first” designation for the first bumper positioning robot arm 120 and the “second” designation for the second bumper positioning robot arm 130 are for description purposes only and do not designate such arms as being in any order of importance or order of use. The control station 190 can be a Fanuc R-30iB controller.

In at least one embodiment, the first and second bumper positioning robot arms 120, 130 are identical robot arms including identical first and second bumper holders 122/132, respectively. In at least one embodiment, the first and second bumper holders 122/132 can be End of Arm Tooling (EOAT), such as vacuum cups to hold bumpers thereon. The first and second bumper holders 122/132 can be quick change type that can be automatically exchanged, on the fly, to accommodate different bumper models. In the example shown, the first and second bumper holders 122/132 are approximately the same width as a bumper. Examples of such bumpers include: G05 Basis, G05 MSP, G07 Basis, G07 MSP, G06 Basis, G06 MSP, F95, and F96, although other types of bumpers can also be used with the automatic bumper processing system 100. In at least one embodiment, the automatic bumper processing system 100 can further include an EOAT tool holder 126 that stores various EOATs while not in use.

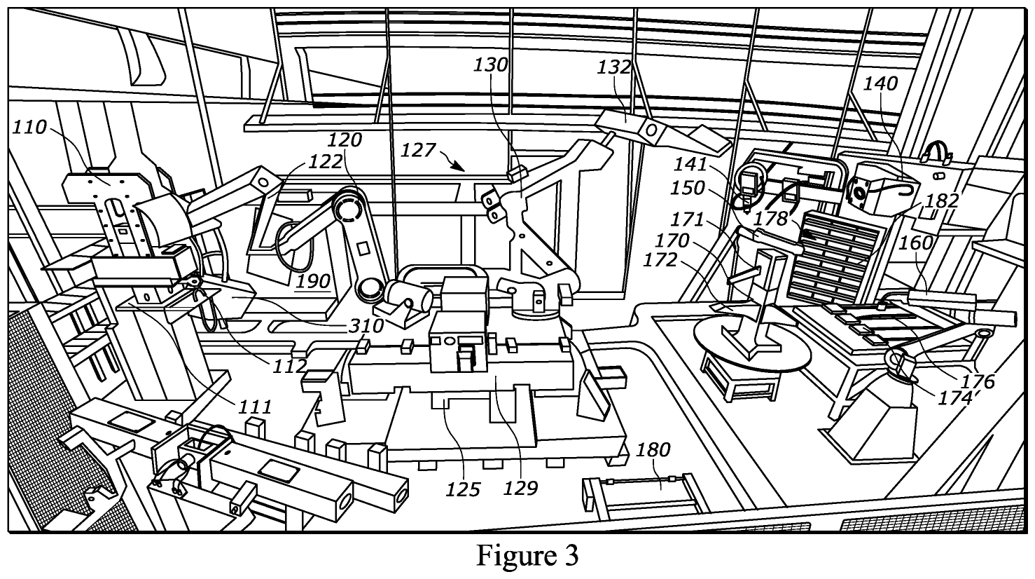

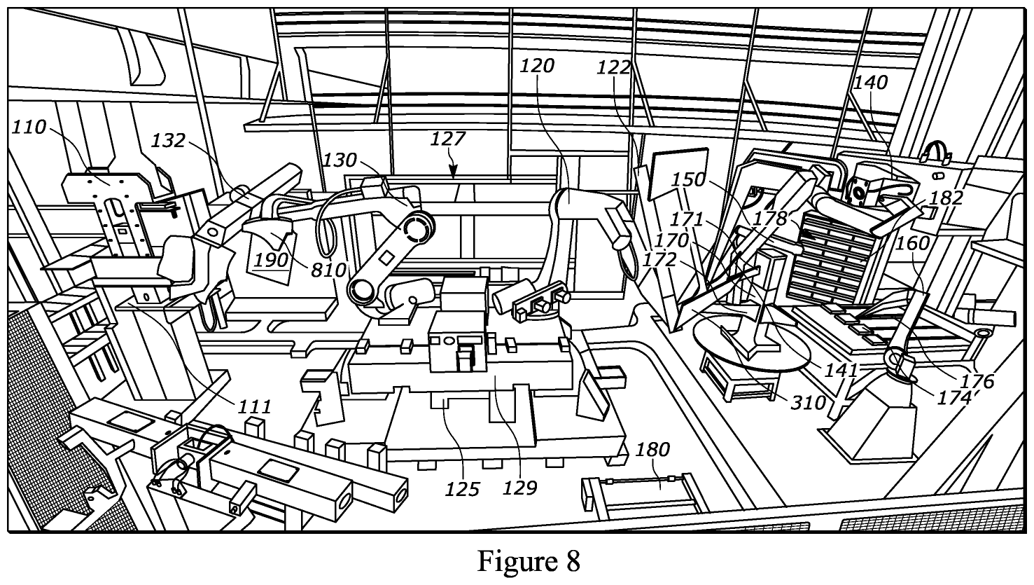

The punch station 110 includes at least one analysis camera 112 (e.g., 3 Dimensional Light Detection and Ranging (3DL) camera) to capture images, such as a first image and a second image, of a first bumper 310 (FIG. 3) and a second bumper 810 (FIG. 8), respectively, when the first bumper positioning robot arm 120 positions the first bumper 310 proximate to the punch station 110 and the second bumper positioning robot arm 130 positions the second bumper 810 proximate to the punch station 110. The punch station 110 further includes a punch mechanism 114. The punch mechanism 114 is activated by the control station 190, i.e., to descend, to push into the first and second bumpers 310, 810 when the first and second bumper positioning robot arms 120, 130 accurately position the first and second bumpers 310, 810, respectively, within the punch station 110 to punch any number of holes as needed in the first and second bumpers 310, 810 at an accurate location(s) at which automotive components 174, such as a parking distance sensor bracket, a side marker reflector, a license plate bracket, and/or any other automotive component, are coupled to the first and second bumpers 310, 810. Many of these automotive components 174 are typically on an “inside” of such bumpers 310, 810 nearest an automobile (not shown) that such bumpers 310, 810 are ultimately coupled to, although automotive components 174 can also be coupled to an “outside” of such bumpers 310, 810, opposite the inside of such bumpers 310, 810.

In at least one embodiment, the punch station 110 is coupled to a rotating punch station platform 111, such that the entire punch station 110 can be rotated between a first position in which punch mechanisms are loaded onto the punch station 110 and a second position in which holes are punched into and through a bumper. The punch station 110 can include a first side 110a and a second side 110b. In the orientation shown in FIG. 1, the first side 110a is oriented away from the first and second bumper positioning robot arms 120, 130 and for loading of other punch mechanisms 114 onto the punch station 110 and the second side 110b is oriented toward the first and second bumper positioning robot arms 120, 130 and positioned for punching holes in a bumper. The punch station 110 can utilize interchangeable die sets or punch mechanisms 114, such that while one punch mechanism 114 is punching hole(s) in a bumper, another punch mechanism 114 is presented to a punch tend robot 115 for loading onto the punch station 110.

The punch station 110 further includes the punch tend robot 115. The punch tend robot 115 picks up a punch mechanism 114 from a die set rack 116 disposed proximate to the punch tend robot 115 and places the picked-up punch mechanism 114 onto a side of the punch station 110 that is not currently being used for punching holes into a bumper. The punch tend robot 115 loads the proper die set or punch mechanism 114 to punch a first hole in a bumper based on the punch sequence for that bumper part type. Once loaded, the punch mechanism 114 is rotated into the punch position and the next punch mechanism 114 needed for the next hole(s) is loaded into the opposite side of the punch station 110. A single bumper can be punched with any number of unique sizes and/or shapes of holes, only requiring a change of the punch mechanisms 114 on the first side 110a and the second side 110b of the punch station 110. Thus, the punch station 110 utilizes a variety of punch mechanisms 114 of various configurations, e.g., diameters and/or shapes such as round, oval, square, or any other shape.

The first and second bumper positioning robot arms 120, 130 perform the same functions, and will therefore be discussed together. The first and second bumper positioning robot arms 120, 130 are coupled to (e.g., secured via bolts or other fasteners) a single robot arm platform 129, such as the first and second bumper positioning robot arms 120, 130 are coupled to opposite ends of the robot arm platform 129, as shown. This robot arm platform 129 is coupled to the rotating mechanism 125 such that the rotating mechanism turns the robot arm platform 129 and the first and second bumper positioning robot arms 120, 130 as one unit. When the robot arm platform 129 is rotated to the position that places the first and second bumper positioning robot arms 120, 130 proximate or near the punch station 110, the first and second bumper positioning robot arms 120, 130 begin bumper processing by picking up the first bumper 310 from a bumper loading area 127. As shown, the bumper loading area 127 is disposed proximate to both the first and second bumper positioning robot arms 120, 130 such that a bumper disposed therein can be picked up by the first and second bumper positioning robot arms 120, 130 when the first and second bumper positioning robot arms 120, 130 are positioned closest to the loading area 127, such as when the first and second bumper positioning robot arms 120, 130 are rotated toward the loading area 127.

In at least one embodiment, the load station 127 can automatically adjust its configuration to accommodate different bumper shapes/styles. The first and second bumper positioning robot arms 120, 130 rotate and articulate to move the first and second bumpers 310, 810 into accurate positions, e.g., an accurate height, depth, left, right, within the punch station 110. When the robot arm platform 129 is rotated to the position that places the first and second bumper positioning robot arms 120, 130 proximate or near the weld station 170, the first and second bumper positioning robot arms 120, 130 rotate and articulate to move the first and second bumpers 310, 810 into accurate positions, e.g., an accurate height, depth, left, right, within the welding station 170 for welding thereof. Once welding is completed by the welding station 170, the first and second bumper positioning robot arms 120, 130 move the first and second bumpers 310, 810 onto a conveyor 180, disposed within reach of the first and second robots 120, 130 when the rotating robot arm platform places the robots on the welding side of the cell, that transports processed (punched and welded) first and second bumpers 310, 810 out of and away from the automatic bumper processing system 100.

The welding station 170 includes one or more welding robot arms, such as welding robot arms 140, 145 each including a welder 141, 142, respectively, e.g., ultrasonic welder, hot plate welder, infrared welder, hot air welder, chemical welder, adhesive welder, and/or any other type of welder, disposed on the non-fixed end thereof to couple the automotive component(s) 174 to the first and second bumpers 310, 810. The welding robot arms 140, 145, under instruction from control station 190, rotate and articulate to move the welders 141, 142 into a proper position, against the automotive component 174 being welded, and to weld, under instruction from control station 190, the automotive component 174 against the first and second bumpers 310, 810, either simultaneously or in sequence.

The welding station 170 further includes at least one support block arm 172, the support block robot arm 150 and the at least one support block arm 172 being disposed proximate to the welding robot arms 140, 145. The at least one support block arm 172 onto which a support block 178 is placed by the support block robot arm 150. Thus, the at least one support block arm 172 supports the support block 178 during welding by the welder 141, 142, the support block 178 supporting the first and second bumpers 310, 810 and/or the automotive components 174 while being welded. In at least one embodiment, the welding station 170 includes multiple support block arms 172 coupled to a turntable 177, with the turntable 177 rotating as support blocks 178 are loaded onto these multiple support block arms 172. The turntable 177 rotates to move the support block 178 into position during welding.

The support block robot arm 150 is located proximate to both the support block storage area 182 and the welding robot arms 140, 145, such that the support block robot arm 150 can reach both the support block storage area 182 and the welding robot arms 140, 145. The support block robot arm 150 rotates and articulates to pick up one support block 178 from a support block storage area 182 and place the support block 178 onto the welding station 170, such as on at least one support block arm 172. The support block storage area 182 stores a variety of support blocks 178 that correspond with a variety of automotive components 174 and/or the first and second bumpers 310, 810, respectively. Each of the variety of automotive components 174 and/or first and second bumpers 310, 810 can have varying shapes that require differently shaped support blocks 178, respectively, such that the automotive components 174 can properly held into place against the first and second bumpers 310, 810 while these variety of automotive components 174 are welded onto the first and second bumpers 310, 810. That is, these support blocks 178 are unique in that they are configured for a particular bumper and a particular location on that bumper, the particular bumper and the particular location having a unique curvature that corresponds to that support block. The support block 178 contacts the automotive components 174 and/or the first and second bumpers 310, 810 to provide support while the welding robot arms 140, 145 press against the automotive components 174 during welding.

The automotive component robot arm 160 is located within the automatic bumper processing system 100 to be able to reach both the automotive component conveyor 176 and the welding station 170. The automotive component robot arm 160 rotates and articulates to pick up the automotive component 174 from the automotive component conveyor 176 and place the automotive component 174 proximate to the welding station 170, such as against a pin located on a second arm 171 disposed above at least one support block arm 172, when the first and second bumpers 310, 810 are moved to the welding station 170. In at least one embodiment, the automotive component conveyor 176 is a conveyor shelf on which the automotive components 174 are disposed. In at least one embodiment, the automotive component conveyor 176 is operator loaded and vision verified to ensure the proper automotive components are loaded for the particular bumper being processed.

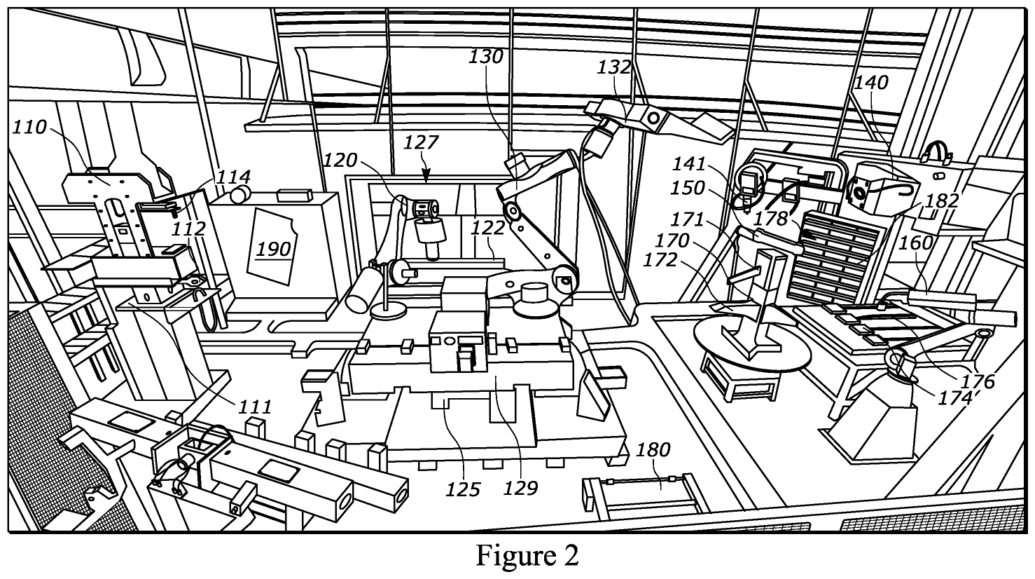

As shown in FIG. 1, during initialization the control station 190 instructs the first and second bumper positioning robot arms 120, 130, the welding robot arms 140, 145, automotive component robot arm 160, and the support block robot arm 150 to move into an initial position awaiting a punch and welding process to begin, as shown. As shown in FIG. 2, the control station 190 instructs the first bumper positioning robot arm 120 to turn from the initial position shown in FIG. 1 and lower its first bumper holder 122 into the bumper loading area 127 to secure the first bumper 310. The remaining of the second bumper positioning robot arm 130, the welding robot arms 140, 145, the automotive component robot arm 160, and the support block robot arm 150 remain in their initial position shown in FIG. 1 awaiting their respective processes to begin.

With reference to FIG. 3, the first bumper positioning robot arm 120 turns from the bumper loading area 127 with the first bumper 310 shown being secured by the first bumper positioning robot arm 120. The first bumper positioning robot arm 120 extends and turns the first bumper 310 in various orientations for at least one analysis camera 112 to capture images that are analyzed by the control station 190. These captured images are analyzed by the control station 190 to determine the specific locations of the holes that need to be punched in the bumper 310. The remaining of the second bumper positioning robot arm 130, the welding robot arms 140, 145, the automotive component robot arm 160, and the support block robot arm 150 continue to remain in their initial positions shown in FIG. 1 awaiting their respective processes to begin.

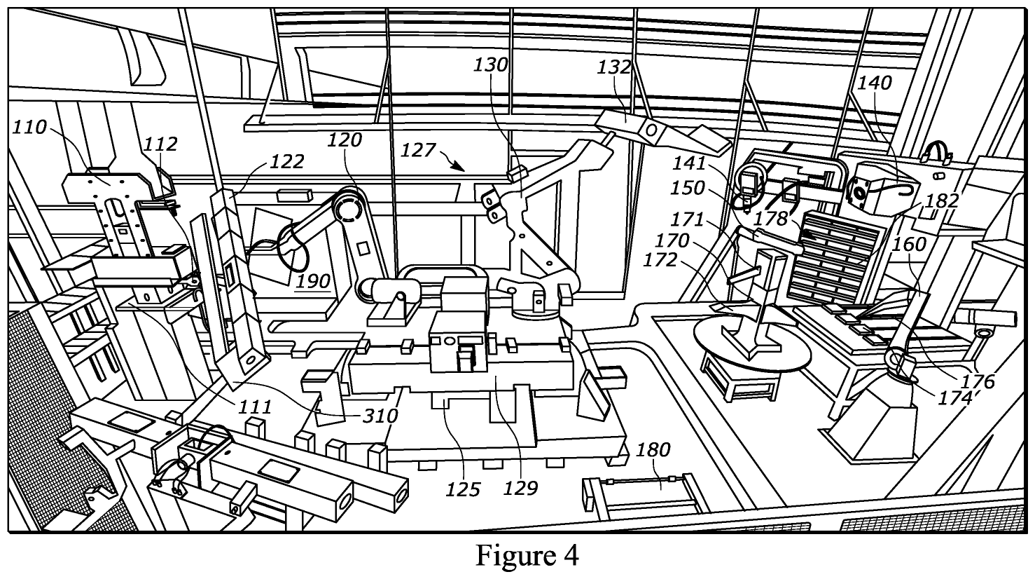

With reference to FIG. 4, the control station 190 instructs the first bumper positioning robot arm 120 to orient and position the first bumper 310 relative to the punch station 110, based on the analysis conducted in FIG. 3, and instructs the punch station 110 to activate the punch mechanism 114 to punch holes in the first bumper 310 at specific pre-programmed locations and orientations based on the image captured by the camera 112, offset by the camera analysis data, while the first bumper positioning robot arm 120 turns the first bumper in various orientations. In at least one embodiment, the punch mechanism 114 pushes into the first bumper 310 at an outside surface of the first bumper 310. The remaining of the second bumper positioning robot arm 130, the welding robot arms 140, 145, the automotive component robot arm 160, and the support block robot arm 150 continue to remain in their initial positions shown in FIG. 1 awaiting their respective processes to begin. As discussed above, the punch tend robot 115 is actively loading die set(s), that is punch mechanism(s), onto the punch station 110 during this cycle, as each hole in the first bumper 310 could be a unique hole size (e.g., diameter) and/or shape (e.g., elliptical, square, round, and/or any other shape utilized by bumpers).

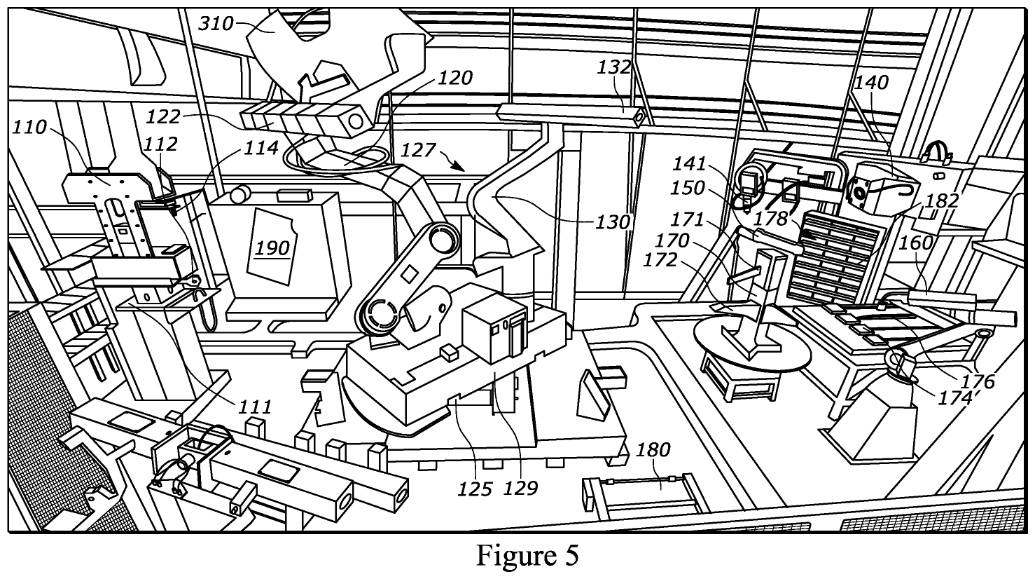

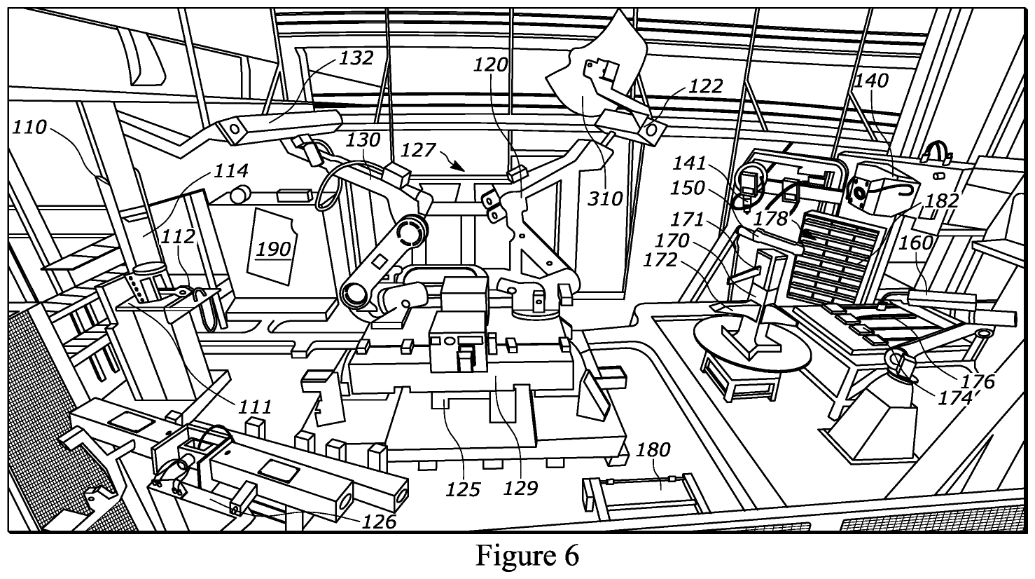

With reference to FIG. 5, once the punch station 110 has completed punching necessary holes in the first bumper 310 the control station 190 instructs the rotating mechanism 125 to rotate the robot arm platform 129 onto which the first and second bumper positioning robot arms 120, 130 are disposed. The robot arm platform 129 is turned 180 degrees such that the first bumper positioning robot arm 120 moves proximate to the welding station 170 and the second bumper positioning robot arm 130 moves proximate to the punch station 110. FIG. 5 illustrates this transition of the first bumper positioning robot arm 120 as it moves proximate to the welding station 170 and the second bumper positioning robot arm 130 as it moves proximate to the punch station 110. With reference to FIG. 6, this transition is complete with the first bumper positioning robot arm 120 shown as being proximate to the welding station 170 and the second bumper positioning robot arm 130 shown as being proximate to the punch station 110.

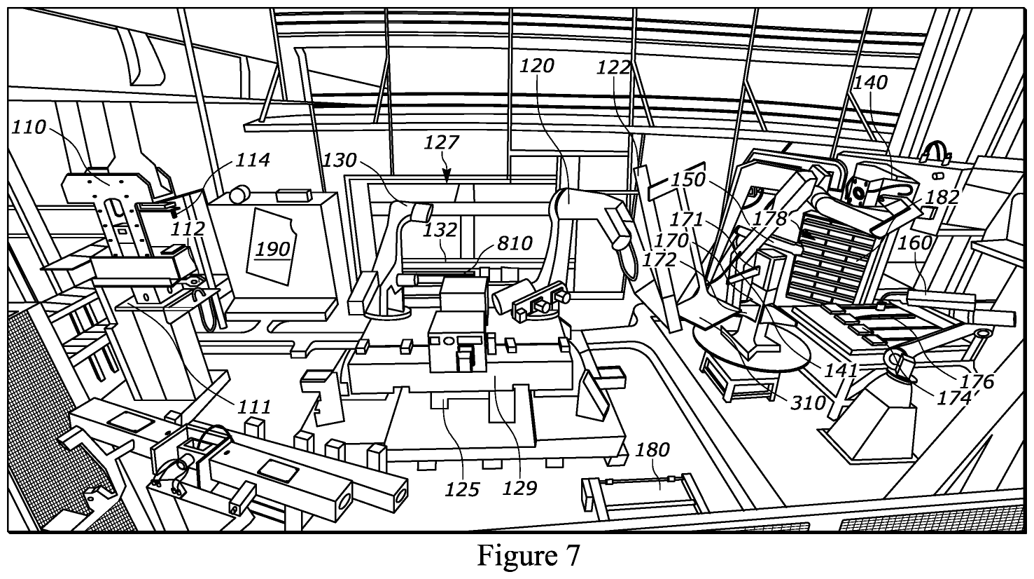

With reference to FIG. 7, based on the analysis of the first bumper 310 in FIG. 3, the control station 190 instructs the automotive component robot arm 160 to select appropriate automotive components 174 from the automotive component conveyor 176 that are to be mounted at particular locations where holes were shown as being punched in FIG. 4 on the first bumper 310. Simultaneously, the control station 190 instructs first bumper positioning robot arm 120 to position the first bumper 310 for mounting of the automotive components 174 selected by the automotive component robot arm 160. Simultaneously, the control station 190 instructs the support block robot arm 150 to select an appropriate support block 178 from the support block storage area 182 and place the support block 178 on at least one support block arm 172, with the control station 190 instructing the welding station 170 to rotate the support block arm 172 into position. The control station 190 instructs the first bumper positioning robot arm 120 to orient and position the first bumper 310 relative to the welding station 170. Once the first bumper 310, the automotive component 176, and the support block arm 172 holding the support block 178 are appropriately positioned, the welding robot arms 140, 145 position the welders 141, 142 against the automotive component 176 to weld or couple the automotive component 176 at the location of the holes punched into the first bumper 310 in FIG. 4. Simultaneously with the automotive component 174 being coupled to the first bumper 310, the control station 190 instructs the second bumper positioning robot arm 130 to rotate and articulate to position the second bumper holder 132 to pick up the second bumper 810 from the bumper loading area 127.

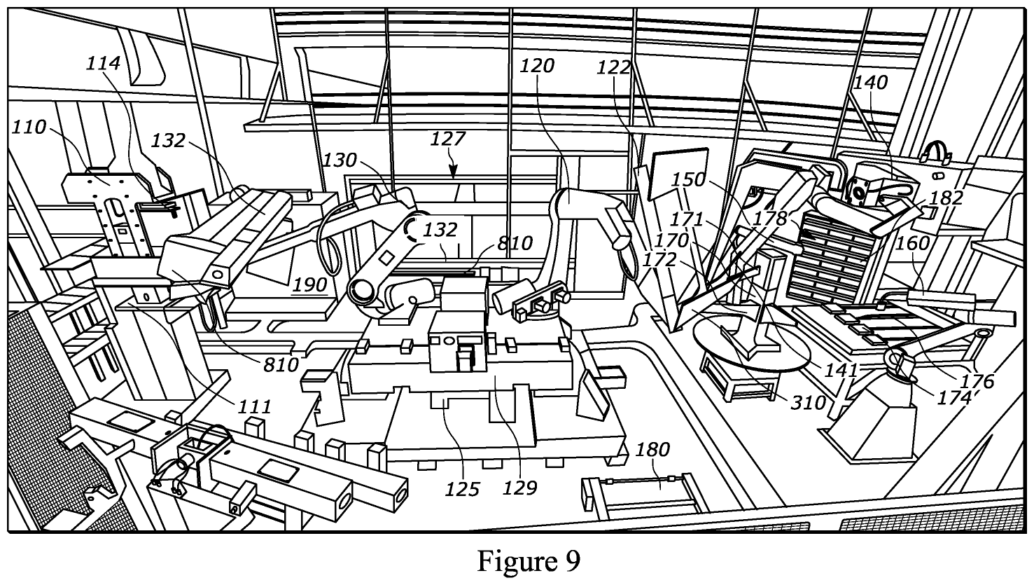

With reference to FIG. 8, the control station 190 instructs the second bumper positioning robot arm 130 to extend and articulate to move the second bumper 810 in various orientations for at least one analysis camera 112 to capture images that are analyzed by the control station 190, as is discussed above in FIG. 3 for the first bumper 310. The welding process described for FIG. 7 for the first bumper 310 continues simultaneously while the second bumper 810 is analyzed. With reference to FIG. 9, the control station 190 instructs the second bumper positioning robot arm 130 to extend and articulate to position the second bumper 810 to continue analyzing the second bumper 810 via the at least one analysis camera 112, as described in FIG. 3 for the first bumper 310. Simultaneously, while the second bumper 810 is being analyzed by the punch station 110, the welding process described for FIG. 7 for the first bumper 310 continues.

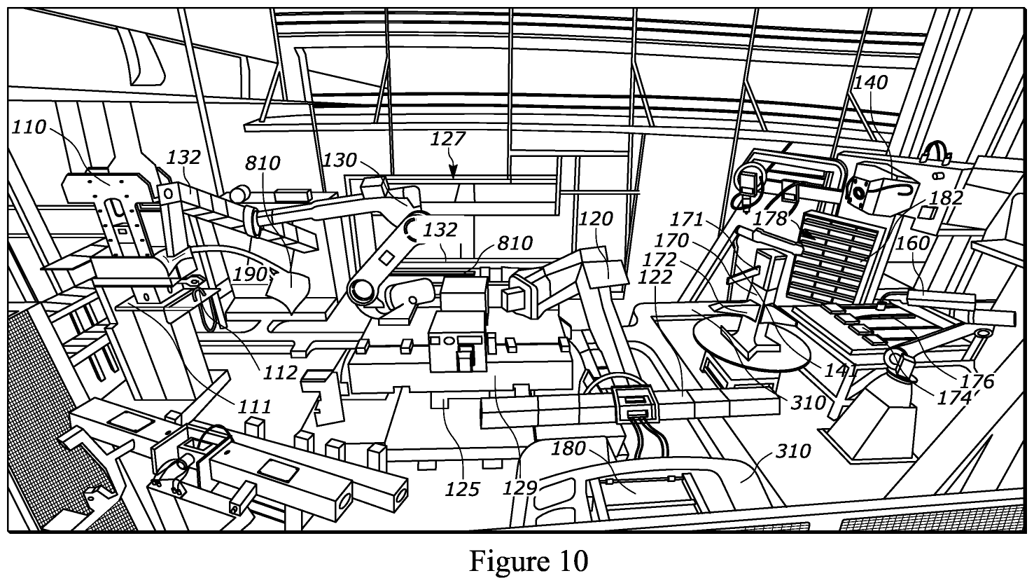

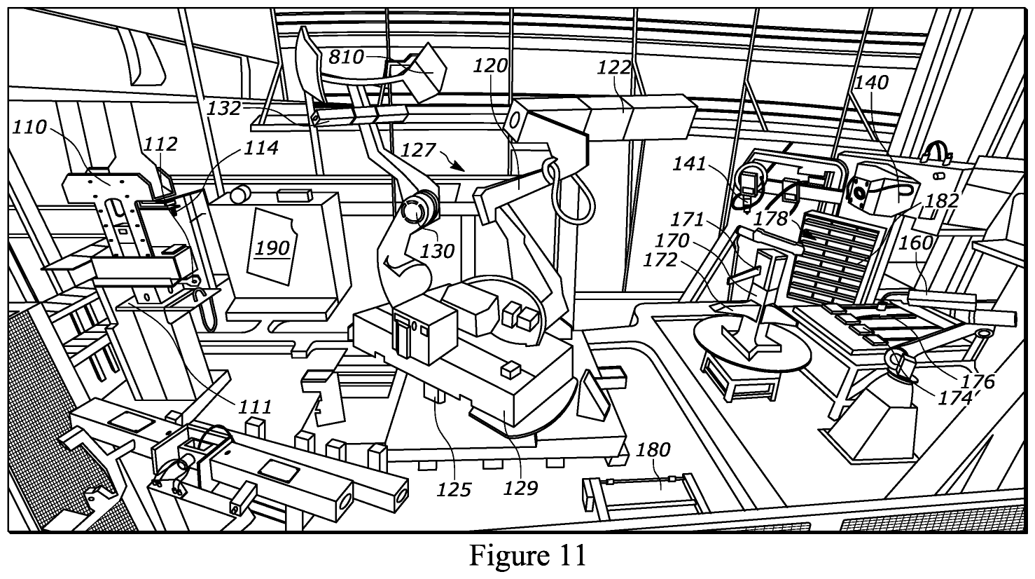

With reference to FIG. 10, the hole punching operation and the coupling of the automotive components 174 to the first bumper 310 has completed. The control station 190 instructs the first bumper positioning robot arm 120 to extend and articulate to place the first bumper 310 onto the conveyor 180 that carries the first bumper 310 out of the automatic bumper processing system 100. With reference to FIG. 11, the control station 190 instructs the rotating mechanism 125 to rotate the robot arm platform 129 to position the second bumper positioning robot arm 130 and the second bumper 810 proximate to the welding station 170 to couple automotive components 174 to the second bumper 810, as described above for the first bumper 310. Thereafter simultaneously, another bumper is secured from the bumper loading area 127 by the first bumper positioning robot arm 120 to begin the process of analyzing and punching holes into this another bumper, as described above for the first and second bumpers 310, 810.

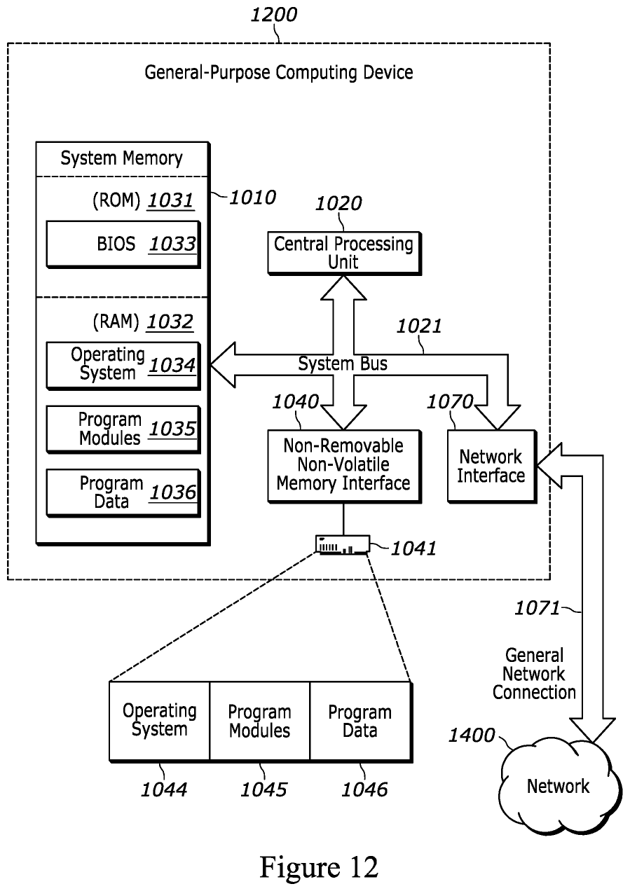

With reference to FIG. 12, the exemplary general-purpose computing device is illustrated in the form of an exemplary apparatus, such as a general-purpose computing device 1200. The general-purpose computing device 1200 may be of the type utilized for the control station 190 (FIGS. 1-11), which controls and instructs the various components of the automatic bumper processing system 100 to perform their functions described herein, as well as any of the other computing devices in the system 100 and with which the control station 190 may communicate through a communication network 1400. In at least one embodiment, the general-purpose computing device 1200 is a distributed computing device. As such, it will be described with the understanding that variations can be made thereto. The exemplary general-purpose computing device 1200 can include, but is not limited to, one or more central processing units (CPUs) 1020, a system memory 1030 and a system bus 1021 that couples various system components including the system memory 1030 to the CPU 1020. The system bus 1021 may be any of several types of bus structures including a memory bus or memory controller, a peripheral bus, and a local bus using any of a variety of bus architectures. Depending on the specific physical implementation, one or more of the CPUs 1020, the system memory 1030 and other components of the general-purpose computing device 1200 can be physically co-located, such as on a single chip. In such a case, some or all of the system bus 1021 can be nothing more than communicational pathways within a single chip structure and its illustration in FIG. 12 can be nothing more than notational convenience for the purpose of illustration.

The general-purpose computing device 1200 also typically includes computer readable media, which can include any available media that can be accessed by the general-purpose computing device 1200. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 1200. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

When using communication media, the general-purpose computing device 1200 may operate in a networked environment via logical connections to one or more remote computers. The logical connection depicted in FIG. 12 is a general network connection 1071 to the communication network 1400, which can be a local area network (LAN), a wide area network (WAN) such as the Internet, or other networks. The general-purpose computing device 1200 is connected to the general network connection 1071 through a network interface or adapter 1070 that is, in turn, connected to the system bus 1021. In a networked environment, program modules depicted relative to the general-purpose computing device 1200, or portions or peripherals thereof, may be stored in the memory of one or more other computing devices that are communicatively coupled to the general-purpose computing device 1200 through the general network connection 1071. It will be appreciated that the network connections shown are exemplary and other means of establishing a communications link between computing devices may be used.

The general-purpose computing device 1200 may also include other removable/non-removable, volatile/nonvolatile computer storage media. By way of example only, FIG. 12 illustrates a hard disk drive 1041 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM 1032, solid state ROM 1031, and the like. The hard disk drive 1041 is typically connected to the system bus 1021 through a non-removable memory interface, such as interface 1040.

The drives and their associated computer storage media discussed above and illustrated in FIG. 12, provide storage of computer readable instructions, data structures, program modules and other data for the general-purpose computing device 1200. In FIG. 12, for example, hard disk drive 1041 is illustrated as storing operating system 1044, other program modules 1045, and program data 1046. Operating system 1044, other program modules 1045 and program data 1046 are given different numbers here to illustrate that, at a minimum, they are different copies.

With reference to FIGS. 1-11, again, the foregoing description applies to the system 100 for automatically punching holes in a bumper and welding automotive components on the bumper, particularly precisely lined up with the punched holes, as well as to any other computing devices in communication with the system 100 through the communication network 1400. The CPU 1020 is coupled to the network interface 1070, such as the transceiver 185. The network interface 1070 facilitates outside communication in the form of voice and/or data. For example, the communication module may include a connection to a Plain Old Telephone Service (POTS) line, or a Voice-over-Internet Protocol (VOIP) line for voice communication. In addition, the network interface 1070 may be configured to couple into an existing network, through wireless protocols (Bluetooth, 802.11a, ac, b, g, n, or the like) or through wired (Ethernet, or the like) connections, or through other more generic network connections. In still other configurations, a cellular link can be provided for both voice and data (i.e., GSM, CDMA or other, utilizing 2G, 3G, and/or 4G data structures and the like). The network interface 1070 is not limited to any particular protocol or type of communication. It is, however, preferred that the network interface 1070 be configured to transmit data bi-directionally, through at least one mode of communication. The more robust the structure of communication, the more manners in which to avoid a failure or a sabotage with respect to communication, such as to communicate an audio segment(s) in a timely manner.

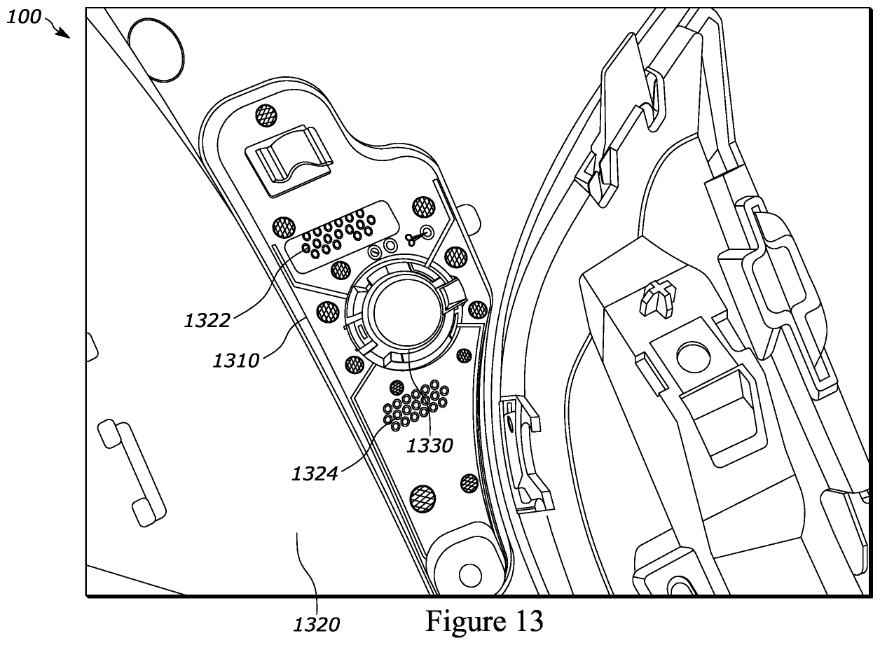

With reference to FIG. 13, an automotive bracket 1310 is illustrated as being coupled to the inside of a bumper 1320 via weld points 1322 and 1324 that are disposed on opposite sides of an example hole 1330, as described above as being punched into a bumper in FIG. 4. As can be seen, the automotive bracket 1310 precisely lines up with the hole 1330.

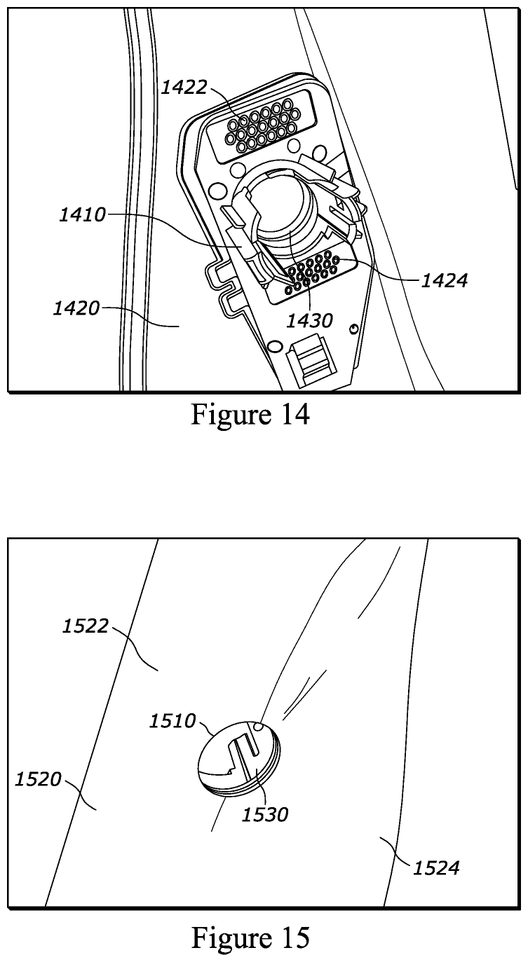

With reference to FIG. 14, another automotive bracket 1410 is illustrated as being coupled to the inside of a bumper 1420 via weld points 1422 and 1424 that are disposed on opposite sides of an example hole 1430, as described above as being punched into a bumper in FIG. 4. Again as can be seen, the automotive bracket 1410 precisely lines up with the hole 1430, this being irrespective of where the automotive bracket 1410 is coupled to the bumper 1420.

With reference to FIG. 15, an outside view of a bumper 1520 is shown, opposite an inside view. As can be seen the hole 1510 that was punched into the bumper 1520, as described above as being punched into a bumper in FIG. 4, again precisely lines up with the automotive bracket 1530. Also seen is that hole 1510 was punched into the bumper 1520 without damaging the bumper 1520 and the weld points (not shown) do not damage the outside surface 1522 of the bumper 1520 at locations 1522/1524 where the weld points are located on the inside of the bumper 1520.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. An automatic bumper processing system, comprising:
a punch station including a camera and a punch mechanism, the camera to capture an image of a bumper and the punch mechanism to punch a hole through the bumper;
a welding station including a welding robot arm including a welder to weld an automotive component onto the bumper;
a bumper positioning robot arm to position the bumper proximate to the punch station and position the bumper proximate to the welding station;
a robot arm platform onto which the bumper positioning robot arm is coupled;
a rotating mechanism to rotate the robot arm platform to position the bumper positioning robot arm proximate to the punch station and the welding station; and
a control station to analyze the image captured by the camera, instruct the bumper positioning robot arm to orient and position the bumper relative to the punch station, instruct the punch station to active the punch mechanism to punch the hole through the bumper at a pre-programmed location based on the image captured by the camera, instruct the bumper positioning robot arm to orient and position the bumper relative to the welding station, and instruct the welder to weld the automotive component onto the bumper.

2. The automatic bumper processing system according to claim 1, wherein the bumper is a first bumper, the bumper positioning robot arm is a first bumper positioning robot arm, the hole is a first hole, and the image is a first image, the automatic bumper processing system further comprising:
a second bumper positioning robot arm, coupled to an opposite end of the robot arm platform from the first bumper positioning robot arm, to position a second bumper proximate to the punch station and position the second bumper proximate to the welding station;
wherein the control station further to analyze a second image of the second bumper captured by the camera, instruct the second bumper positioning robot arm to orient and position the second bumper relative to the punch station, instruct the punch station to active the punch mechanism to punch a second hole through the second bumper at a pre-programmed location based on the second image captured by the camera, and instruct the second bumper positioning robot arm to orient and position the second bumper relative to the welding station.

3. The automatic bumper processing system according to claim 1, wherein the punch mechanism is a first punch mechanism and the hole is a first hole, the punch station further comprising a punch tend robot to load a second punch mechanism into the punch station to punch a second hole into the bumper, the second hole having a different configuration than the first hole.

4. The automatic bumper processing system according to claim 1, further comprising a support block storage area, disposed proximate to the welding robot arm, to store a plurality of support blocks that support the bumper while being welded.

5. The automatic bumper processing system according to claim 4, further comprising a support block robot arm and a support block arm, both of which are disposed proximate to the welding robot arm, the support block robot arm to pick up a support block from the plurality of support blocks and place the support block onto the support arm.

6. The automatic bumper processing system according to claim 1, wherein the welding robot arm is a first welding robot arm and the welder is a first welder, the welding station further including a second welding robot arm and a second welder to weld the automotive component onto the bumper.

7. The automatic bumper processing system according to claim 1, wherein the welder is one of an ultrasonic welder, hot plate welder, infrared welder, hot air welder, chemical welder, and an adhesive welder.

8. The automatic bumper processing system according to claim 1, wherein the automotive component is one of a parking sensor bracket and a reflector.

9. The automatic bumper processing system according to claim 1, wherein the bumper positioning robot arm is a Fanuc R-2000iC/165F robot arm and the control station is a Fanuc R-30iB controller.

10. The automatic bumper processing system according to claim 1, wherein the camera is a 3 Dimensional Light Detection and Ranging (3DL) camera.

11. A method of automatically processing a bumper via an automatic bumper processing system, the method comprising:
capturing, by a camera disposed within a punch station, an image of a bumper;
punching, by a punch mechanism disposed within the punch station, a hole through the bumper;
welding, by a welding station including a welding robot arm, an automotive component onto the bumper;
positioning, by a robot arm, the bumper proximate to the punch station and the welding station;
rotating, by a rotating mechanism, a robot arm platform coupled to the robot arm to position the robot arm proximate to the punch station and the welding station; and
analyzing, by a control station, the image captured by the camera;
instructing, by the control station, the robot arm to orient and position the bumper relative to the punch station;
instructing, by the control station, the punch station to active the punch mechanism to punch the hole through the bumper at a pre-programmed location based on the image captured by the camera;
instructing, by the control station, the robot arm to orient and position the bumper relative to the welding station; and
instructing, by the control station, the welder to weld the automotive component onto the bumper.

12. The method of automatically processing a bumper according to claim 11, wherein the bumper is a first bumper, the bumper positioning robot arm is a first bumper positioning robot arm, the hole is a first hole, and the image is a first image, the method further comprising:
positioning, by a second bumper positioning robot arm coupled to an opposite end of the robot arm platform from the first bumper positioning robot arm, a second bumper proximate to the punch station;
positioning, by the second bumper positioning robot, the second bumper proximate to the welding station;
analyzing, by the control station, a second image of the second bumper captured by the camera;
instructing, by the control station, the second robot positioning robot arm to orient and position the second bumper relative to the punch station;
instruct, by the control station, the punch station to active the punch mechanism to punch a second hole through the second bumper at a pre-programmed location based on the second image captured by the camera; and
instructing, by the control station, the second bumper positioning robot arm to orient and position the second bumper relative to the welding station.

13. The method of automatically processing a bumper according to claim 11, wherein the punch mechanism is a first punch mechanism, and the hole is a first hole, the method further comprising loading, by a punch tend robot, a second punch mechanism into the punch station to punch a second hole into the bumper, the second hole having a different configuration than the first hole.

14. The method of automatically processing a bumper according to claim 11, further comprising storing, by a support block storage area disposed proximate to the welding robot arm, a plurality of support blocks that support the bumper while being welded.

15. The method of automatically processing a bumper according to claim 14, further comprising picking up, by a support block robot arm disposed proximate to the welding robot arm, a support block from the plurality of support blocks; and
placing, by the support block robot arm, the support block onto a support arm disposed proximate to the welding robot arm.

16. The method of automatically processing a bumper according to claim 11, wherein the welding robot arm is a first welding robot arm and the welder is a first welder, the method further comprising welding, by a second welding robot arm and a second welder both disposed within the welding station, the automotive component onto the bumper.

17. The method of automatically processing a bumper according to claim 11, wherein the welder is one of an ultrasonic welder, hot plate welder, infrared welder, hot air welder, chemical welder, and an adhesive welder.

18. The method of automatically processing a bumper according to claim 11, wherein the automotive component is one of a parking sensor bracket and a reflector.

19. The method of automatically processing a bumper according to claim 11, wherein the bumper positioning robot arm is a Fanuc R-2000iC/165F robot arm and the control station is a Fanuc R-30iB controller.

20. The method of automatically processing a bumper according to claim 11, wherein the camera is a 3 Dimensional Light Detection and Ranging (3DL) camera.
